(19) United States
(12) Patent Application Publication
(10) Pub. No.: US 2012/0198213 A1
(43) Pub. Date: Aug. 2, 2012

(54) PACKET HANDLER INCLUDING PLURALITY OF PARALLEL ACTION MACHINES

(75) Inventors: Francois Abel, Rueschlikon (FR); Jean Calvignac, Raleigh, NC (US); Christoph Hagleitner, Wallisellen (CH); Fabrice Verplanken, LaGaude (FR)

(73) Assignee: INTERNATIONAL BUSINESS MACHINES CORPORATION, Armonk, NY (US)

(21) Appl. No.: 13/017,949

(22) Filed: Jan. 31, 2011

(51) Int. Cl. G06F 9/30

(52) U.S. Cl. 712/225; 712/E09.023

(57) ABSTRACT

A packet handler for a packet processing system includes a plurality of parallel action machines, each of the plurality of parallel action machines being configured to perform a respective packet processing function; and a plurality of action machine input registers, wherein each of the plurality of parallel action machines is associated with one or more of the plurality of action machine input registers, and wherein an action machine of the plurality of parallel action machines is automatically triggered to perform its respective packet processing function in the event that data sufficient to perform the actions machine's respective packet processing function is written into the action machine's one or more respective action machine input registers.

### BACKGROUND

This disclosure relates generally to the field of the inspection and processing of data received over a communication channel, and in particular to a packet handler including a plurality of parallel action machines for use in a packet processing system.

A computing system includes a central processing unit (CPU) that performs execution of instructions and processing of data. A lexicon of machine commands understood by the CPU are referred to as an instruction set of the CPU. A CPU instruction set may include a list of basic computing operations, referred to as opcodes. Some example opcodes include set, load, add, multiply, jump, and branch-on-condition. A unit of data that is processed by the CPU is referred to as an operand. During CPU processing, one or more operands are associated with an opcode to specify the data on which the opcode operation is to be performed to form an instruction.

The time required to execute an instruction by the CPU is an important metric for assessment of performance of the CPU. CPU execution time is a measure of a number of seconds that a CPU takes to perform a task or a program, the program being made up of a plurality of instructions. CPU execution time may be expressed in terms of instruction count (IC), i.e. the number of instructions included in the task or program; an average number of clock cycles required per instruction (CPI); and the clock rate (F) of the CPU. Therefore, CPU execution time is equal to: (IC×CPI)/F, and may be reduced by reducing the CPI or increasing the F. The CPI of a computing system CPU may be reduced by increasing instruction level parallelism of the computing system. To increase parallelism, some packet processing tasks may be shifted from the CPU to a received packet processing system of the computing system.

### BRIEF SUMMARY

In one aspect, a packet handler for a packet processing system includes a plurality of parallel action machines, each of the plurality of parallel action machines being configured to perform a respective packet processing function; and a plurality of action machine input registers, wherein each of the plurality of parallel action machines is associated with one or more of the plurality of action machine input registers, and wherein an action machine of the plurality of parallel action machines is automatically triggered to perform its respective packet processing function in the event that data sufficient to perform the actions machine's respective packet processing function is written into the action machine's one or more respective action machine input registers.

In another aspect, a method of operating a packet handler of a packet processing system, the packet handler comprising a plurality of parallel action machines, each of the plurality of parallel action machines being configured to perform a respective packet processing function includes causing data to be written into one or more action machine input registers corresponding to an action machine of the plurality of parallel action machines; and in the event the one or more action machine input registers contains data sufficient to perform their corresponding actions machine's respective packet processing function, automatically triggering the corresponding action machine to perform its respective packet processing function using the data in the one or more action machine input registers corresponding to the action machine.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 is a schematic block diagram illustrating an embodiment of a packet processing system with a packet handler.

FIG. 2 is a schematic block diagram illustrating an embodiment of a packet handler including a plurality of parallel action machines.

FIG. 3 is a schematic block diagram illustrating an embodiment of an action machine filler for a packet handler including a plurality of parallel action machines.

FIG. 4 is a schematic block diagram illustrating an embodiment of an opcode decoder.

FIG. 5 is a flow chart illustrating an embodiment of a method that may be implemented in a packet handler including a plurality of parallel action machines.

FIG. 6 is a schematic block diagram illustrating an embodiment of a computing system that may be used in conjunction with a packet handler including a plurality of parallel action machines.

### DETAILED DESCRIPTION

Embodiments of a packet handler including a plurality of parallel action machines are provided, with exemplary embodiments being discussed below in detail. A packet handler in a received packet processing system may process data received by the computing system at data line rates through use of a plurality of parallel action machines. The parallel action machines are independent execution units, each assigned to a particular packet processing function, so as to reduce the complexity of the individual action machines. An action machine is automatically triggered by receipt of data sufficient to perform the action machine's particular packet processing function. The packet handler may be controlled by instructions, wherein instruction opcodes are issued from a packet parser of the packet processing system, and instruction operands are received from a data path of the packet processing system. Instruction opcodes control the writing of instruction operands to the action machines, with the number of instruction opcodes being less-than-or-equal to the number of instruction operands. Because the number of instruction opcodes is tied to the number of instruction operands and not to the number of action machines, the size of the instruction vector used to control the packet handler remains relatively small when the number of action machines increases.

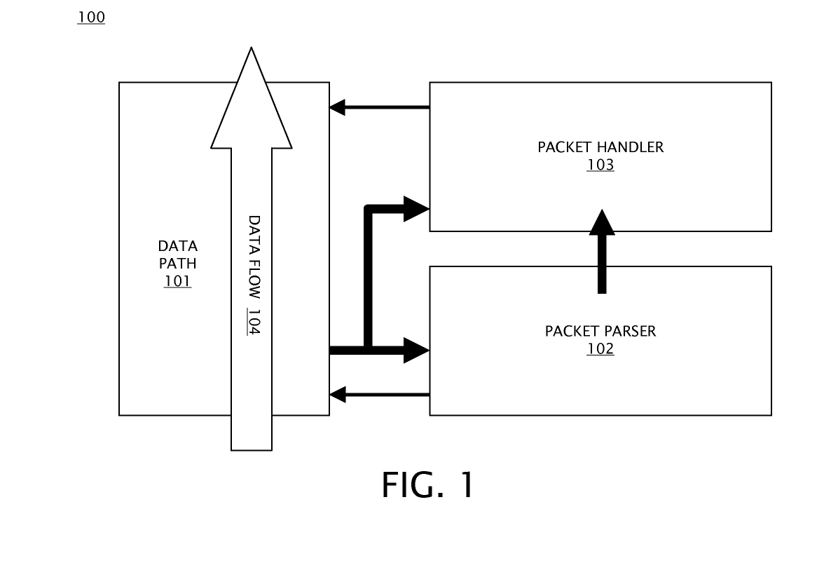

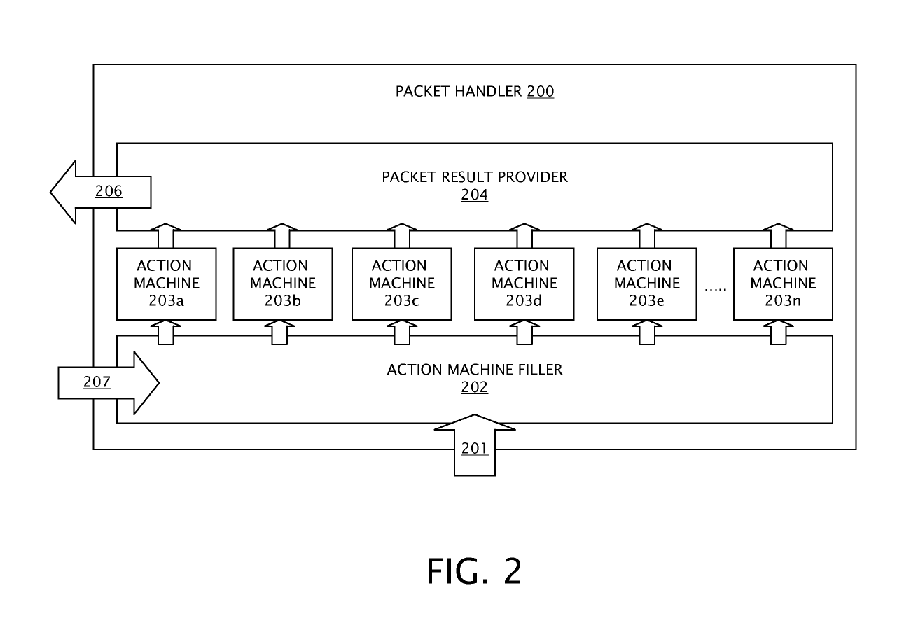

FIG. 1 illustrates an embodiment of a packet processing system 100 with a packet handler 103. Packet processing system 100 includes a data path (DP) 101 that exposes the content of a data flow 104 to a packet parser (PP) 102, and a packet handler (PH) 103 that performs packet processing operations for packet processing system 100 under control of the PP 102. Data flow 104 may include any flow of data received by a computing system in which the packet processing system 100 is embodied, and may be formatted according to any appropriate protocol. As data flow 104 progresses through the DP 101, the DP 101 receives requests for data from data flow 104 from PP 102. The DP 101 extracts the requested fields from the packets in the data flow 104 based on the requests from the PP 102. The extracted fields are passed to both the PP 102 and the PH 103. The PP 102 uses the extracted fields for parsing and for triggering specific packet handling actions from the PH 103, while the PH 103 uses the extracted fields as operands for the specific packet handling actions requested by PP 102. The PP 102 defines bundles of instructions to be executed in parallel based on the extracted data from DP 101, and sends the bundles of instructions to the PH 103. The PH 103 receives the bundles of instructions from the PP 102, and uses a set of parallel action machines (AMs) operated in parallel (discussed below with respect to FIG. 2) to perform the instructions issued by the PP 102.

FIG. 2 illustrates an embodiment of a PH 200 including a plurality of parallel AMs 203a-n. FIG. 2 is discussed with reference to FIG. 1, and PH 103 in the packet processing system 100 discussed above with respect to FIG. 1 may comprise PH 200 of FIG. 2. AM filler 202 receives instruction opcodes from the PP 102 over PH input 201. Each opcode describes one or multiple packet processing functions to be performed by PH 200. Each individual AM of AMs 203a-n is an independent execution unit that performs a particular packet processing function when triggered by AM filler 202. The AM filler 202 triggers one or more AM(s) of AMs 203a-n to perform an operation based on the instruction's opcode. An AM is triggered to perform its particular packet processing function by receipt of the operands necessary for execution of the AM's particular packet processing function. After function execution, the AMs provide the results of the function execution to packet result provider 204. The packet result provider 204 may then provide the results received from the AMs to the PP 102, to the input of another AM, or to any other appropriate component of the computing system in which packet processing system 100 is located.

AMs 203a-n are shown for illustrative purposes only; a PH 200 may include any desired number of AMs, and the AMs may be assigned to any appropriate packet processing functions. Multiple AMs may be assigned to the same packet processing function in some embodiments. Each AM of AMs 203a-n performs its respective packet processing function in parallel with the other AMs. Each AM function may require a single clock cycle to execute in some embodiments. Example functions that may be performed by an individual AM include but are not limited to classification, filtering, such as VLAN or MAC address filtering, hashing, discarding and checksum verification, such as TCP or IP checksum verification. Each AM of AMs 203a-n may implement microcode and/or hard-wired function required for implementing its particular function in various embodiments. AMs 203a-n may be reset into a clean starting state whenever a new packet processing task is required by PP 102; all the AMs 203a-n may be reset whenever the PP 102 detects an end-of-packet in some embodiments, such that AMs 203a-n are ready to start processing the next packet as soon as a start-of-packet is detected by PP 102.

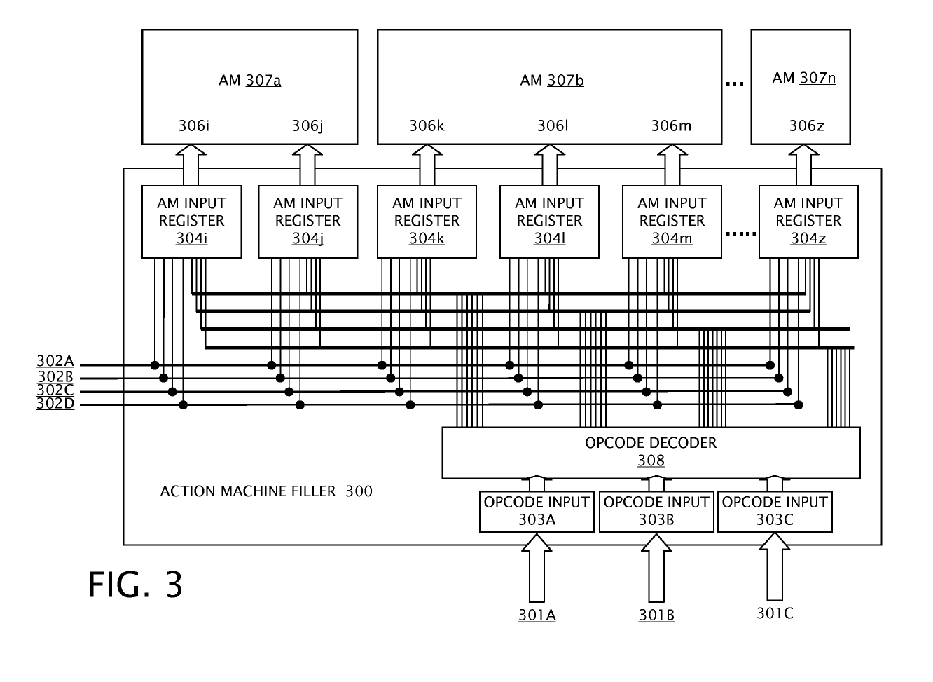

FIG. 3 shows a block diagram of an embodiment of an AM filler 300. FIG. 3 is discussed with reference to FIGS. 1 and 2, and AM filler 202 discussed above with respect to FIG. 2 may comprise AM filler 300 of FIG. 3. AM filler 202 interfaces with the inputs of AMs 203a-n of FIG. 2 via respective AM input registers 304i-z. The total number of AM input registers 304i-z is equal to the sum of the inputs 306i-z of AMs 307a-n. AM filler 300 receives instructions, including opcodes, from PP 102, and operands from DP 101. The opcodes are placed into opcode input registers 303A-C via operand inputs 301A-C. The opcode input registers 303A-C are connected to an opcode decoder 308. Operands required to perform the packet processing functions defined by the opcodes are received in a data-flow manner through operand inputs 302A-D. Each of operand inputs 302A-D are connected to each of AM input registers 304i-z. The AM input registers 304i-z include a set of write registers to hold the operands received from operand inputs 302A-D; the opcode decoder 308 determines which of operand inputs 302A-D write into which of AM input registers 304i-z. In some embodiments, operands may also be included in the instruction with the opcode, and passed from an opcode input register to one or more AM input registers.

In a single clock cycle, a single operand input may write into multiple AM input registers, and/or a single AM input register may receive operands from multiple operand inputs, as required by the opcodes in opcode input registers 303A-C. The presence of data sufficient to perform an AM's packet processing function in its respective AM input register automatically triggers the AM to perform its packet processing function using the data in its respective AM input register. The size of an AM's respective AM input register may vary depending upon the packet processing function performed by the AM. For example, an Ethernet MAC address filter AM requires an input register of 48 bits to hold an entire MAC address. The size of an AM input register also depends upon the size of the atomic parsing element used by the PP 102, as the size of the operands are matched with the size of the atomic parsing element. For example, since protocols carried over a network are typically byte-oriented, an Ethernet protocol packet processing system might operate with an atomic parsing element of 8 bits (a byte), which would translate into 6 target registers (48/8) being instantiated in a MAC filter AM input register. A single opcode may trigger a single AM or multiple AMs, based on unicast (UC) and multicast (MC) encoding of the opcodes, as is explained below.

Operand inputs 302A-D may provide operands in a data-flow manner from DP 101, PP 102, packet result provider 204, or any other appropriate component of the computing system in which packet processing system 100 is located. Operand inputs 302A-D and opcode input registers 303A-C are shown for illustrative purposes only; an AM filler may include any appropriate number of operand inputs (which may be connected to any appropriate data source within the computing system), and any appropriate number of opcode input registers. The number of operand inputs and the number of opcode inputs in an AM filler 300 is may be less than or equal to the total number of AMs 203a-n in the PH 103. The size of an operand received on an operand input may be selected to correspond to the size of an atomic parsing element (e.g. digit, byte, word) that best suits the processing requirements of the packet processing system 100 in which PH 102 is located. The number of opcode input registers 303A-C determines the number of opcodes that may be included in an instruction bundle from PP 102.

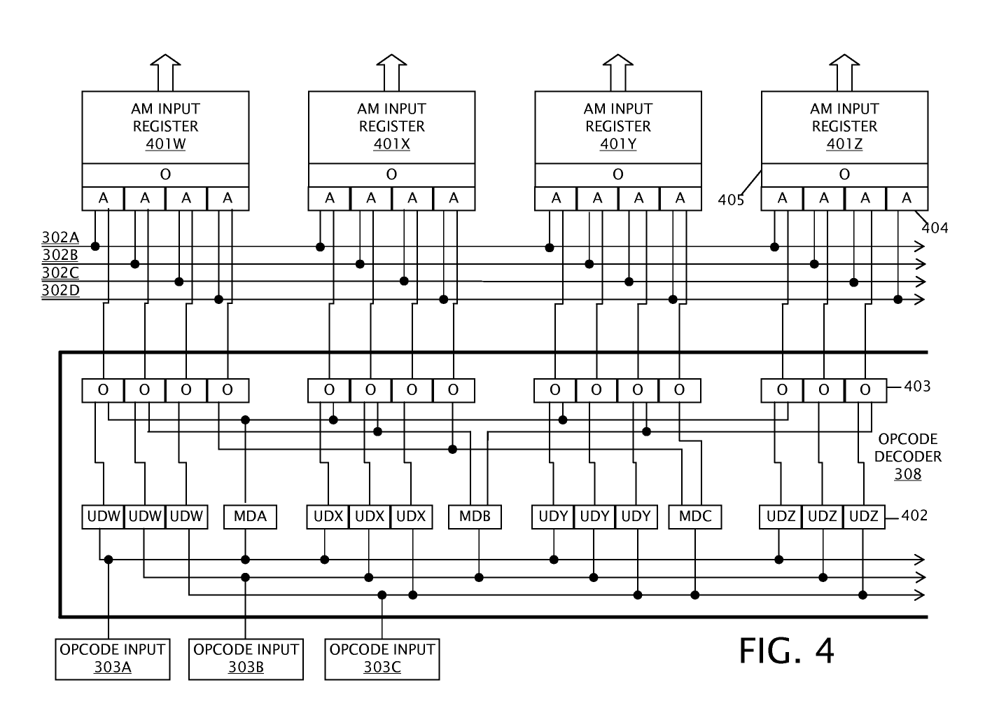

FIG. 4 illustrates a detailed view of the opcode decoder 308 of FIG. 3. FIG. 4 is discussed with reference to FIG. 3. Four exemplary AM input registers 401W-Z are shown in FIG. 4; all of AM input registers 401W-Z may be associated with a single AM in some embodiments, or with one or more different AMs in other embodiments. Each of AM input register 401W-Z has an output connected to the associated AM. Each of AM input registers 401W-Z receives operands from the operand inputs 302A-D. The selection of which operand input of operand inputs 302A-D writes into the which of AM input registers 401W-Z depends upon the values of the opcodes in the opcode input registers 303A-C. In various embodiments, the number of operand inputs 302A-D may be the same as or different from the number of opcodes input registers 303A-C (in the embodiment of FIG. 4, there are 4 operands versus 3 opcodes).

Opcode decoder 308 comprises logic (i.e., logic row 402) to match the opcodes in opcode input registers 303A-C and AM input registers 401AW-Z comprise logic enabling writing from operand inputs 302A-D based on the matched opcodes. A box with a ‘O’ (such as boxes 403 and 405) corresponds to a logical “OR” function, and a box with a ‘A’ (such as box 404) corresponds to a logical “AND” function. An opcode in any of opcode input registers 303A-C may be a unicast (UC) opcode or a multicast (MC) opcode. A UC opcode is used to write a single operand into a single AM input register. For example, if the opcode in opcode input 303A equals a unicast decode value corresponding to AM input register 401W (i.e., UDW), then the operand carried over operand input 302A is written into AM input register 401W. Similarly, if the opcode in opcode input 303B also equals the unicast value corresponding to AM input register 401W (UDW), then the operand carried over operand input 302B is also written into AM input register 401W. A MC opcode is used to write an operand into multiple AM input registers. For example, if the opcode in opcode input 303A is a multicast decode value MDA, then the operand carried over operand input 302A is written into four AM input registers i.e., AM input registers 401W-Z. An MC opcode may be used to write multiple operands into multiple different input registers. For example, the multicast opcode MDB in opcode input 303B causes the operand carried over operand input 302B to written into AM input registers 401W and 401X, and operand carried over operand input 302C to be written into AM input registers 401Y and 401Z. An MC opcode, such as MDC, may also decode multiple multicast opcodes values. For example, if the opcode in opcode input 303C equals the first multicast decode value of MDC, then the operand carried over operand input 302D gets written into AM input registers 401W and 401X, while if opcode in opcode input 303C equals the second multicast decode value of MDC, then operand carried over operand input 302D is only written into AM input register 401Y. A code compiler may be implemented to avoid a conflict situation in which two opcodes attempt to write to the same AM input register in the same cycle. FIG. 4 is shown for illustrative purposes only; the logic comprising an opcode decoder and AM input registers may be configured in any appropriate manner.

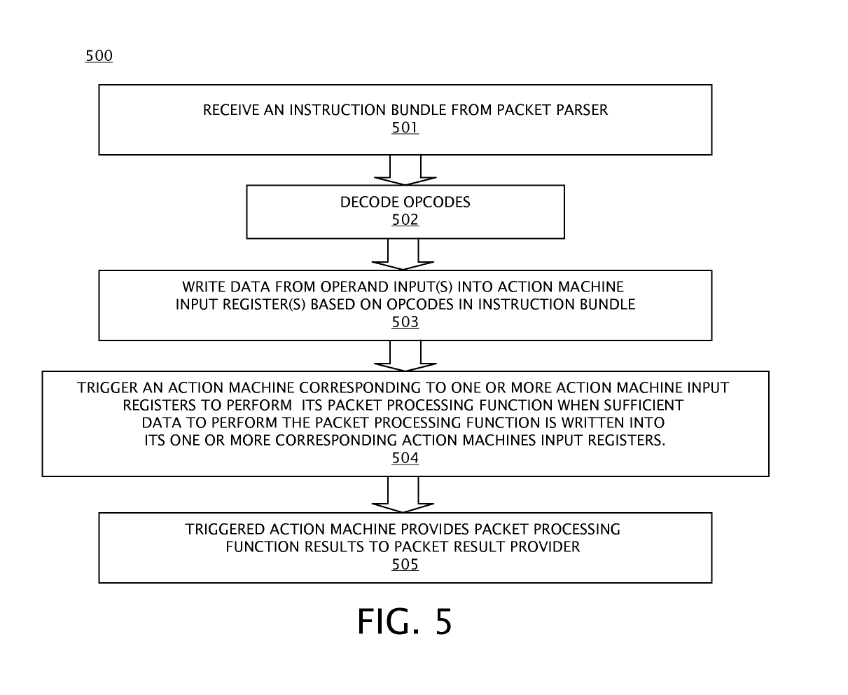

FIG. 5 is a flow chart illustrating an embodiment of a method 500 that may be implemented in a packet handler including a plurality of parallel action machines. FIG. 5 is discussed with reference to FIGS. 1-4. In block 501, an AM filler (202, 300) of the packet handler (103, 200) receives an instruction bundle including one or more opcodes from a packet parser (102). The one or more opcodes are placed into respective opcode input registers (303A-C). In block 502, each opcode in the respective opcode input registers 303A-C is decoded. In block 503, each decoded opcode causes data to be written into one or more AM input registers 304i-z from the operand inputs 302A-D. In block 504, each AM of AMs 203a-n associated with one or more AM input registers 304i-z into which data was written in block 503 are triggered to perform the AM's particular function using the data in the AM's respective AM input register(s). Each AM is automatically triggered by the presence of data sufficient to perform the AM's particular packet processing function in the AM's respective AM input register(s). In block 505, each AM that performed its function in block 504 provides a function result to a packet result provider 204.

Method 500 of FIG. 5 is now discussed with reference to the parsing and the handling of a source address of an Internet Protocol (IP) version 4 datagram. Such an IPv4 source address is composed of four bytes which might be received by AM filler (202, 300) over the operand inputs 302A-D. A minimum of three AMs might be involved in the handling of the IPv4 source address: a hasher AM which computes a 5-tuple hash identifying the TCP/IP flow, an IP checksum AM which verifies the IPv4 checksum of the received datagram, and a TCP checksum AM which verifies the TCP checksum of the received datagram. In block 501, an instruction bundle from PP 102 is received by AM filler 202 over PH input 201. The instruction bundle received in block 501 includes a single multicast opcode requesting operations from the above three AMs: the hasher, the IP checksum and the TCP checksum. The multicast opcode is assumed to be stored in input opcode register 303A. In block 502, the multicast opcode in opcode input register 303A is decoded by the opcode decoder 308. In block 503, the decoder 308 causes the operands needed by the hasher, the IP checksum and the TCP checksum, to be written from one or more of operand inputs 302A-D into the corresponding four input registers of the three AMs. As a result, 3×4 input registers are written at once into 3 different AMs. In block 504, the IP checksum and the TCP checksum AMs that received operands in their AM input registers in block 503 are automatically triggered because they received sufficient data to perform their corresponding packet processing function. The 2 AMs execute their packet processing functions in parallel. The execution of the hasher function is not triggered because the AM did not yet receive all the data required to compute the 5-tuple hash. In block 505, the results of the function execution in block 504 are provided to packet result provider 204, which may provide the results to any appropriate component of the computing system, including but not limited to the PP 102 or another AM input via one or more of the operand inputs 302A-D. Note that 2 opcodes out of the 3 from the instruction bundle remain usable for writing data into additional AMs. In another embodiment, the instruction bundle received in block 501 may include three multicast opcodes, each requesting a separate operation from the above three AMs: the hasher, the IP checksum and the TCP checksum.

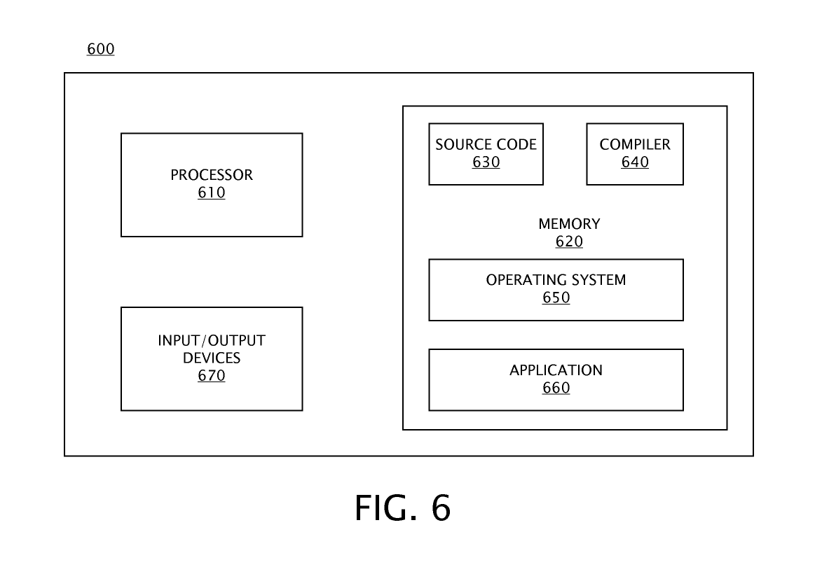

FIG. 6 illustrates an example of a computer 600 which in which a packet handler including a plurality of parallel AMs may be embodied. Various operations discussed above may utilize the capabilities of the computer 600. A packet handler including a plurality of parallel AMs may be incorporated in any element, module, application, and/or component discussed herein, such as input and/or output (I/O) devices 670.

The computer 600 includes, but is not limited to, PCs, workstations, laptops, PDAs, palm devices, servers, storages, and the like. Generally, in terms of hardware architecture, the computer 600 may include one or more processors 610, memory 620, and one or more I/O devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a digital signal processor (DSP), or an auxiliary processor among several processors associated with the computer 600, and the processor 610 may be a semiconductor based microprocessor (in the form of a microchip) or a macroprocessor.

The memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and one or more applications 660 in accordance with exemplary embodiments. As illustrated, the application 660 comprises numerous functional components for implementing the features and operations of the exemplary embodiments. The application 660 of the computer 600 may represent various applications, computational units, logic, functional units, processes, operations, virtual entities, and/or modules in accordance with exemplary embodiments, but the application 660 is not meant to be a limitation.

The operating system 650 controls the execution of other computer programs, and provides scheduling, input-output control, file and data management, memory management, and communication control and related services. It is contemplated by the inventors that the application 660 for implementing exemplary embodiments may be applicable on all commercially available operating systems.

Application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 670 may include input devices such as, for example but not limited to, a mouse, keyboard, scanner, microphone, camera, etc. Furthermore, the I/O devices 670 may also include output devices, for example but not limited to a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or intranet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include relatively fast operation of a packet handler in a packet processing system, with relatively a short format for instructions passed between the packet parser and the packet handler.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A packet handler for a packet processing system, comprising:
a plurality of parallel action machines, each of the plurality of parallel action machines being configured to perform a respective packet processing function; and
a plurality of action machine input registers, wherein each of the plurality of parallel action machines is associated with one or more of the plurality of action machine input registers, and wherein an action machine of the plurality of parallel action machines is automatically triggered to perform its respective packet processing function in the event that data sufficient to perform the actions machine's respective packet processing function is written into the action machine's one or more respective action machine input registers.

2. The packet handler of claim 1, wherein the packet handler is configured to receives an opcode from a packet parser of the packet processing system, the opcode designating one or more parallel action machines of the plurality of parallel action machines.

3. The packet handler of claim 2, wherein the packet handler receives the opcode into one of a plurality of opcode input registers located in the packet handler, the plurality of opcode input registers being connected to the plurality of action machine input registers

4. The packet handler of claim 3, wherein the opcode is received from the packet parser in a bundle of instructions, each of the instructions in the bundle of instructions comprising an opcode designating one or more parallel action machines of the plurality of parallel action machines, and wherein the number of instructions in the bundle of instructions is less than or equal to the number of opcode input registers.

5. The packet handler of claim 2, wherein the opcode causes the data sufficient to perform the packet processing function of the one or more parallel action machines designated by the opcode to be written into the one or more action machine input registers corresponding to the one or more designated parallel action machines.

6. The packet handler of claim 2, further comprising a plurality of operand inputs connected to the plurality of action machine input registers, wherein data is written into the action machine input registers from the plurality of operand inputs in a data-line manner based on the opcode.

7. The packet handler of claim 6, wherein at least one operand input of the plurality of operand inputs provides data from the packet parser of the computing system.

8. The packet handler of claim 6, wherein at least one operand input of the plurality of operand inputs provides data from a data path of the computing system.

9. The packet handler of claim 6, wherein at least one operand input of the plurality of operand inputs provides data from an output of at least one of the plurality of parallel action machines.

10. The packet handler of claim 1, wherein a packet processing function comprises one of classification, filtering, hashing, discarding, and checksum verification.

11. A method of operating a packet handler of a packet processing system, the packet handler comprising a plurality of parallel action machines, each of the plurality of parallel action machines being configured to perform a respective packet processing function, the method comprising:
causing data to be written into one or more action machine input registers corresponding to an action machine of the plurality of parallel action machines; and
in the event the one or more action machine input registers contains data sufficient to perform their corresponding actions machine's respective packet processing function, automatically triggering the corresponding action machine to perform its respective packet processing function using the data in the one or more action machine input registers corresponding to the action machine.

12. The method of claim 11, further comprising receiving an opcode by the packet handler from a packet parser of the packet processing system, the opcode designating one or more parallel action machines of the plurality of parallel action machines.

13. The method of claim 12, wherein the packet handler receives the opcode into one of a plurality of opcode input registers located in the packet handler, the plurality of opcode input registers being connected to the plurality of action machine input registers

14. The method of claim 13, wherein the opcode is received from the packet parser in a bundle of instructions, each of the instructions in the bundle of instructions comprising an opcode designating one or more parallel action machines of the plurality of parallel action machines, and wherein the number of instructions in the bundle of instructions is less than or equal to the number of opcode input registers.

15. The method of claim 12, wherein the opcode causes the data sufficient to perform the packet processing function of the one or more parallel action machines designated by the opcode to be written into the one or more action machine input registers corresponding to the one or more designated parallel action machines.

16. The method of claim 12, further comprising writing the data into the action machine input registers in a data-line manner from a plurality of operand inputs connected to the plurality of action machine input registers based on the opcode.

17. The method of claim 16, further comprising providing data from the packet parser of the computing system on at least one operand input of the plurality of operand inputs.

18. The packet handler of claim 6, further comprising providing data from a data path of the computing system on at least one operand input of the plurality of operand inputs.

19. The packet handler of claim 6, further comprising providing data from an output of at least one of the plurality of parallel action machines on at least one operand input of the plurality of operand inputs.

20. The packet handler of claim 1, wherein a packet processing function comprises one of classification, filtering, hashing, discarding, and checksum verification.
